(19) United States
(12) Patent Application Publication
(10) Pub. No.: US 2016/0301587 A1
(43) Pub. Date: Oct. 13, 2016

(54) APPARATUS, SYSTEM AND METHOD FOR FAST LEADER ELECTION BY COORDINATION SERVICE

(71) Applicant: Alibaba Group Holding Limited, George Town (KY)

(72) Inventor: Binbin ZHENG, Hangzhou (CN)

(21) Appl. No.: 15/093,286

(22) Filed: Apr. 7, 2016

(30) Foreign Application Priority Data
Apr. 9, 2015 (CN) 201510165922.2

(51) Int. Cl. H04L 12/26; H04L 12/24; G06F 17/30; H04L 29/06

(52) U.S. Cl. CPC H04L 43/0817; H04L 69/16; H04L 41/0893; H04L 41/0816; G06F 17/30979

(57) ABSTRACT

A method of fast leader election by a coordination service servicing clients including determining whether the servers of the coordination service are in the state of leader election. In response to a determination that the servers of the coordination service are in the state of leader election, the method also includes configuring the servers of the coordination service in a state of rejecting requests from the clients. The method further includes determining whether the servers of the coordination service are in a state of servicing the clients. In response to a determination that the servers of the coordination service are in the state of servicing the clients, the method further includes configuring the servers of the coordination service in a state of receiving requests from the clients.

### CROSS REFERENCE TO RELATED APPLICATION

This application claims benefit to Chinese Patent Application No. 201510165922.2, filed on Apr. 9, 2015, which is incorporated herein by reference in its entirety.

### TECHNICAL FIELD

The present invention relates generally to software providing coordination services for distributed applications, and more particularly to a method, system and apparatus for fast leader election by a coordination service for distributed systems.

### BACKGROUND

The ZooKeeper™ service is a reliable coordination system targeting distributed systems of large scale. As a distributed service framework, the ZooKeeper™ service is primarily utilized for solving problems of coordination in a cluster of distributed systems or distributed applications. Typically, the ZooKeeper™ service provides for functionalities such as configuration maintenance, naming, synchronization and grouping services for distributed applications. The ZooKeeper™ service includes two parts: a server end and a client end. A client at the client end utilizes and maintains a TCP connection, through which it sends requests, gets responses, gets watch events, sends heart beats, etc.

In order to ensure data consistency in a distributed environment, the ZooKeeper™ service needs to elect a leader among all the servers of the service to become responsible for managing the clusters of servers of the service. Consequently, the rest of the ZooKeeper™ servers become the followers of the elected leader. Further, when a leader quits servicing due to malfunction or other reasons, it is necessary for the ZooKeeper™ servers to quickly elect a new leader among the followers of the prior leader. During the period when the ZooKeeper™ service is in the process of electing a leader, the ZooKeeper™ servers enter a state called leader election, which is also called a recovery mode or recovery state. After a new leader is elected, the leader election state or the recovery mode terminates such that the ZooKeeper™ service returns to its normal operating mode of servicing external clients.

Currently, during a leader election state, the ZooKeeper™ servers cannot provide services to external clients. For a cluster of a large scale, such as ZooKeeper™ service, it means thousands of clients serviced by the ZooKeeper™ service are visiting and waiting in parallel and re-visiting. After receiving the requests, the ZooKeeper™ servers consult their own data and record a log. When the ZooKeeper™ service is in the state of leader election, it is unable to return data to a client. Receiving and processing a large amount of client requests increase the load pressure of the ZooKeeper™ servers, causing interference and delays to the normal process of leader election. In the worst case, the process of leader election either cannot complete, or end in failure, as a result of which the ZooKeeper™ service cannot provide the corresponding service.

Therefore, there exists a need for a fast leader election by a coordination service, e.g., ZooKeeper™ service, to solve the problem of the client service requests interfering with the process of leader election of the coordination service.

### SUMMARY

The embodiments of the present disclosure provide for a method, apparatus and system for fast leader election by a coordination service of distributed systems, e.g., the ZooKeeper™ service system, to solve the present problem of the client service requests interfering with the process of the leader election by the servers of the coordination service.

According to an exemplary embodiment of the present disclosure, a method of fast leader election by a coordination service for distributed systems includes determining whether the servers of a coordination service are in a state of leader election. In response to a determination that the servers of the coordination service are in the state of leader election, the method includes configuring the servers of the coordination service in a state of rejecting client requests. The method also includes determining whether the servers of the coordination service are in a state of client servicing. In response to a determination that the servers of the coordination service are in the state of servicing clients, the method further includes configuring the servers of the coordination service in a state of receiving requests from the clients.

According to another exemplary embodiment of the present disclosure, an apparatus for fast leader election by a coordination service for distributed systems includes a leader election status determination module, a client-request-rejecting configuration module, a servicing status determination module and a client-request-receiving configuration module. The leader election status determination module is configured to determine whether the servers of the coordination service are in a state of leader election. The client-request-rejecting configuration module is implemented to configure, in response to a determination that the servers of the coordination service are in the state of leader election, the servers of the coordination service in a state of rejecting client requests. The servicing status determination module is configured to determine whether the servers of the coordination service are in a state of client servicing. The client-request-receiving configuration module is implemented to configure, in response to a determination that the servers of the coordination service are in the state of client servicing, the servers of the coordination service in a state of receiving requests from clients.

Compared to the prior art technologies, the embodiments of the present disclosure provide for the following advantages. Using the ZooKeeper™ service as an exemplary coordination service for distributed systems, during the period of leader election, the ZooKeeper™ servers are configured as not to receive service requests from clients. After the process of leader election terminates and with the new leader elected, the ZooKeeper™ servers return to the normal mode of servicing external clients. At this point, the prior configuration where the ZooKeeper™ servers reject service requests is cleared such that the ZooKeeper™ servers again receive and process service requests the clients. Thus, the ZooKeeper™ servers will not be interfered by the client service requests during the period of leader election. Further, the proces of leader election by the ZooKeeper™ servers will not be delayed or slowed down or end in failure. Therefore, it can be ensured that the process of leader election of the ZooKeeper™ servers can be completed in a fast and successful manner such that the client service requests can be serviced as soon and as fast as possible. This minimizes the impact to the networked coordination service by the process of leader election, decreases the amount of down time of the ZooKeeper™ service, and increases the reliability of the ZooKeeper™ service overall.

### DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is an illustration of an exemplary system environment in which an embodiment of the present disclosure may operate;

FIG. 2 is a flow chart of an exemplary method of leader election by a coordination service for distributed systems in accordance with an embodiment of the present disclosure; and

FIG. 3 is a block diagram of an exemplary apparatus performing leader election within a coordination service for distributed systems in accordance with an embodiment of the present disclosure.

### DETAILED DESCRIPTION

In the following description, numerous specific details are set forth in order to provide a thorough understanding of the present disclosure. However, it will become obvious to those skilled in the art that the present disclosure may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the disclosure do not inherently indicate any particular order nor imply any limitations in the disclosure.

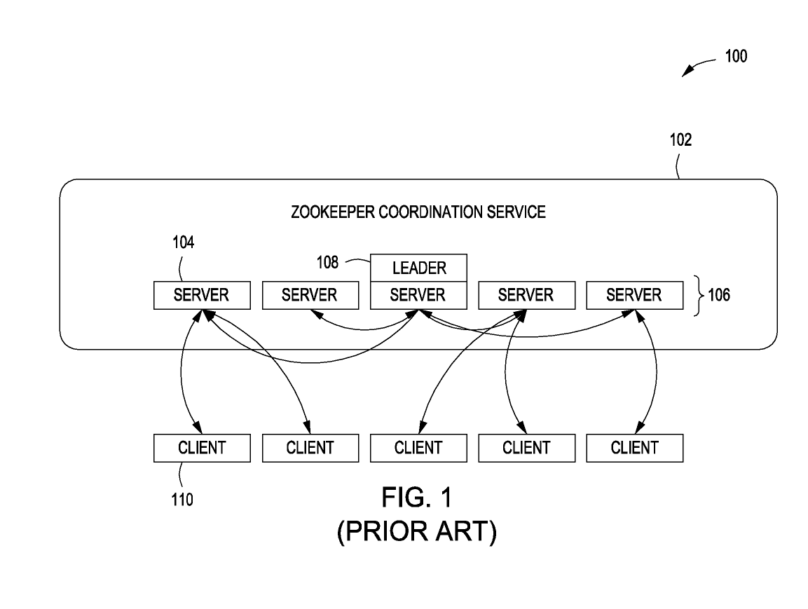

FIG. 1 illustrates an exemplary system environment 100 in which an embodiment of the present disclosure may operate. As shown in FIG. 1, the environment 100 includes a coordination service for distributed systems such as, for example, the ZooKeeper™ service 102. In some other embodiments, the environment 100 may include any other services that provide for coordination services for distributed systems or applications, as well as the combination thereof. The ZooKeeper™ coordination service 102 includes a group of servers 106 which includes individual servers 104. In the group of servers 106, one server may act as a leader 108, the role of which is to accept and coordinate transactions. All other servers, e.g., servers other than the leader 108 in the group of servers 106 may act as followers of the leader 108. If the connection to the server 104 breaks, the client 110 will connect to a different server.

If the leader 108 becomes unavailable, for example, when the leader 108 fails or crashes, any other followers may be elected as a new leader by the group of servers 106; and the rest of the followers of the prior leader may become the followers of the new leader. Client 110 may connect to the coordination service 102, e.g., connect to a server of the group of servers 106. The client 110 may maintain the connection, through which it sends requests, gets responses, gets watch events, and sends heart beats, etc.

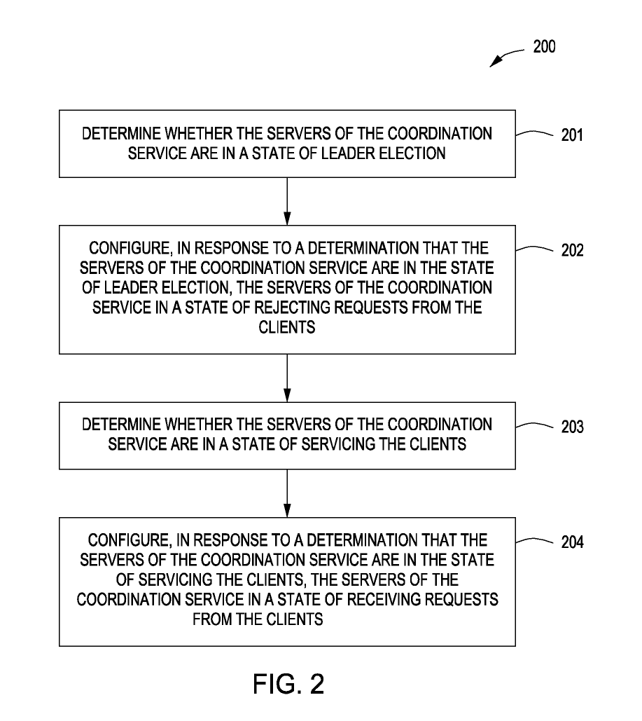

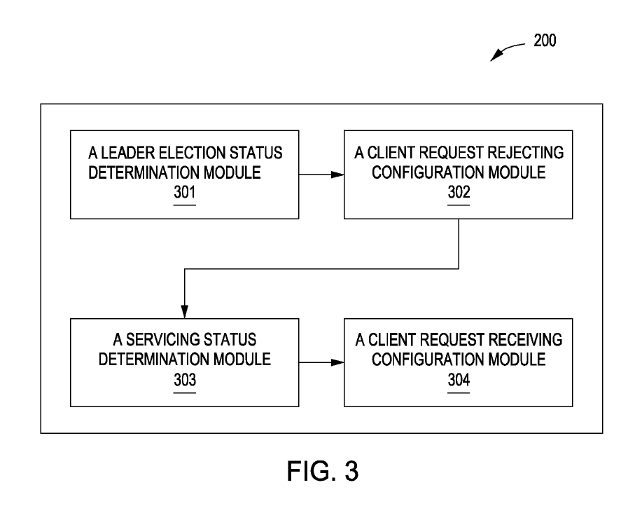

Embodiments of the present disclosure are discussed herein with reference to FIGS. 2-3. However, those skilled in the art will readily appreciate that the detailed description given herein with respect to these figures is for exemplary explanatory purposes as the disclosure extends beyond these particular embodiments.

Referring to FIG. 2, a flow chart of an exemplary method of fast leader election by a coordination service for distributed systems is shown in accordance with embodiments of the present disclosure. The method 200 may be used in a coordination service for distributed systems such as, for example, the ZooKeeper™ service 102 of FIG. 1. In some other embodiments, the method 200 may also be used in any other coordination services for distributed systems and/or the combination thereof.

The method 200 is used, based on a log file of the ZooKeeper™ service, or its reply information, responsive to certain commands, to determine whether the servers of the ZooKeeper™ service have entered a state of leader election or a state of providing service to external clients. After it is determined whether the servers of the ZooKeeper™ service system have entered into a state of leader election or a state of providing service to external clients, by use of a networking utility such as, for example, iptables, a rule can be set in the packet processing tables of the servers of the ZooKeeper™ service to reject or receive requests from the clients. Such packet processing tables (IP tables) include, but are not limited to, a filter table, a network address translation (NAT) table, a mangle table as well as an input chain and a pre-routing chain thereof. In some embodiments, the servers of the ZooKeeper™ service receive requests from the clients at TCP port 2181.

Method 200 starts in step 201, where it is determined whether the servers of the ZooKeeper™ system are in the state of leader election. Multiple ways can be implemented to determine whether the servers of the ZooKeeper™ system are in the state of leader election, and the following illustrates three examples thereof.

First, an output log file (e.g., zookeeper.out) of the servers can be read to analyze whether presently there are repeated output of information indicating a status of “leader election”, e.g., information including key words such as “Fast Leader Election”. For example, if the log file of zookeeper.out of the servers is printing out the information that indicates “. . . . Fast leaser Election @542]—Notification:2 (n.leader) . . . ”, it can be determined that the servers of the ZooKeeper™ system have entered in the state of leader election. Otherwise, it is determined that the servers have not entered the state of leader election.

Second, it can be determined whether the servers of a ZooKeeper™ service system have entered in the state of leader election by use of the network commands such as, for example, a “status” command and a “netstat” command, to query the servers and analyze the responses returned therefrom. For example, when a status command “#sh zkServer.sh status” is utilized to query the servers, they may respond with a message indicating a status of “error contacting service, service may not be running”, e.g., including key words such as “Error contacting service. It is probably not running”. For another example, the servers of the ZooKeeper™ service system may respond with a message of:
“JMX enabled by default
Using config: /home/admin/zookeeper-3.3.3/bin/../conf/zoo.cfg
Error contacting service. It is probably not running”.
   With this response message indicating that the ZooKeeper™ service is malfunctioning, by use of a “netstat” command with parameters, for example, “#netstat—itp|grep 2181”, the servers of the ZooKeeper™ system can be further queried. This exemplary parameterized netstat command specifies to display the status of the programs of the servers that respond to network traffic at the TCP port 2181 with a state of “LISTEN”, the IP protocol addresses of which are represented in digital format. If the servers of the ZooKeeper™ service system respond to the above described command with a feedback output such as, for example, a message of “TCP 0 0 0 .0.0.2181 0.0.0.0:*LISTEN 26436/java”, this indicates that the TCP port at which the servers receive requests from the clients is in a mode of “LISTEN”, which is an active mode. Together with the above described information of the ZooKeeper™ service malfunctioning, it can be determined that the servers have entered the state of leader election.

On the contrary, if the response from the servers of the ZooKeeper™ service system to a “status” command does not include any relevant key words such as, e.g., “Error contacting service. It is probably not running” or the servers do not respond to a “netstat—nltp|grep 2181” command, it can be determined that the servers have not entered the state of leader election.

Third, a four letter command “ruok” of the ZooKeeper™ service can be utilized to query the servers of the ZooKeeper™ service system. For example, when a command of “#echo ruok |nc 127.0.0.1 2181” is utilized, if the servers respond with information that does not include any key words such as, for example, “imok”, it can be determined that servers have entered into the state of leader election. Otherwise, it can be determined that the servers of the ZooKeeper™ service have not entered into the state of leader election.

When it is determined that the ZooKeeper™ servers have not entered the state of leader election, method 200 continues back to step 201 to monitor whether the servers are in the state of leader election by use of, for example, one of the above described the first, second or third examples. When it is determined that the ZooKeeper™ service system has entered the state of leader election, method 200 proceeds to step 202.

In step S202, the servers of the ZooKeeper™ service system are configured in a state of rejecting requests from clients. Multiple ways can be implemented to configure the servers of the ZooKeeper™ service to reject requests from clients, and the following illustrates four examples thereof.

First, a network utility such as, for example, iptables utility can be utilized to add a rule of DROP for the TCP port 2181 in the input chain of the filter tables of the servers to reject service requests from clients. An exemplary command can be “iptables—A INPUT—p TCP—drop 2181—j DROP”.

Second, the iptables utility can also be utilized to add a rule of DROP for the TCP port 2181 in the input chain of the mangle tables of the servers to reject service requests from clients. An exemplary command can be “iptables—t mangle—A INPUT—p TCP—drop 2181—j DROP”.

Third, the iptables utility can also be utilized to add a rule of DROP for the TCP port 2181 in the pre-routing chain of the mangle tables of the servers to reject service requests from clients. An exemplary command can be “iptables—t mangle—A PREROUTING—p TCP—drop 2181—j DROP”.

Fourth, the iptables utility can also be utilized to add a rule of DROP for the TCP port 2181 in the pre-routing chain of the NAT tables of the servers to reject service requests from clients. An exemplary command can be “iptables—t nat—A PREROUTNG—p TCP-drop 2181—j DROP”.

In step 203, it is determined whether the servers of the ZooKeeper™ service have entered a state of providing service to external clients. Multiple ways can be implemented to determine whether the servers of the ZooKeeper™ service are in the state of servicing external clients, and the following illustrates two examples thereof.

First, a ZooKeeper™ command such as, for example, a four letter command “ruok” can be utilized to query the servers of the ZooKeeper™ service system. For example, when a command of “#echo ruok |nc 127.0.0.1 2181” is utilized, if the servers respond with information that includes any key words such as, for example, “imok”, it can be determined that servers have entered the state of providing service to external clients. Otherwise, it can be determined that the servers have not entered the state of providing service to external clients.

Second, another ZooKeeper™ “status” command such as, for example, “#sh zkServer.sh status” can be utilized to query the servers of the ZooKeeper™ service system. If the servers respond with information indicating with the parameter of MODE as “leader” or “follower”, it is determined that the servers are in the state of servicing external clients. For example, when the servers respond with the following message:
“JMX enabled by default
Using config: /home/admin/zookeeper-3.4.3/bin/../conf/zoo.cfg
Mode: follower”
Or,
“JMX enabled by default
Using config: /home/admin/zookeeper-3.4.3/bin/../conf/zoo.cfg
Mode: leader”,
   it can be determined that the servers have entered the state of servicing external clients. On the contrary, if the servers respond with information that does not indicate with the parameter of MODE as “leader” or “follower”, it is determined that the servers have not entered the state of providing service to external clients.

When it is determined that the servers of the ZooKeeper™ system have not entered the state of servicing external clients, method 200 continues back to step 203 to monitor the status of the servers by use of, for example, the above described examples. Otherwise, when it is determined that the servers have entered the state of servicing external clients, method 200 proceeds to step 204.

In step 204, the servers of the ZooKeeper™ service are configured back to the state of receiving service requests from clients. Step 204 corresponds to how the servers of the ZooKeeper™ service are configured in the state of rejecting service requests from clients in the above described step 202. In other words, different corresponding parameters and commands are utilized to clear the state configured in step 202 for the servers to reject requests from clients such that they return to receiving service requests from clients.

First, if the iptables utility is utilized to add a rule of DROP for the TCP port 2181 in the input chain of the filter tables of the servers of the ZooKeeper™ service system to reject service requests from clients in step 202, e.g., if the command of “iptables—A INPUT—p TCP—drop 2181—j DROP” is utilized in step 202, the iptables utility is utilized to delete the above described rule of DROP in the input chain from the filter tables of the servers such that the servers are configured back to the state of receiving the service requests from clients. An exemplary command can be “iptables—D INPUT—p TCP—dport 2181—j DROP”.

Second, if the iptables utility is utilized to add a rule of DROP for the TCP port 2181 in the input chain of the mangle tables of the servers of the ZooKeeper™ service system to reject service requests from clients in step 202, e.g., if the command of “iptables—t mangle—A INPUT—p TCP—drop 2181—j DROP” is utilized in step 202, the iptables utility is utilized to delete the above described rule of DROP in the input chain from the mangle tables of the servers such that the servers are configured back to the state of receiving the service requests from clients. An exemplary command can be “iptables—t mangle—D INPUT—p TCP-dport 2181—j DROP”.

Third, if the iptables utility is utilized to add a rule of DROP for the TCP port 2181 in the pre-routing chain of the mangle tables of the servers of the ZooKeeper™ service system to reject service requests from clients in step 202, e.g., the command of “iptables—t mangle—A PREROUTING—p TCP—drop 2181—j DROP” is utilized in step 202, the iptables utility is utilized to delete the above described rule of DROP in the pre-routing chain from the mangle table of the servers such that the servers are configured back to the state of receiving the service requests from clients. An exemplary command can be “iptables—t mangle—D PREROUTING—p TCP—dport 2181—j DROP”.

Fourth, if the iptables utility is utilized to add a rule of DROP for the TCP port 2181 in the pre-routing chain of the NAT tables of the servers of the ZooKeeper™ service system to reject service requests from clients in step 202, e.g., the command of “iptables—t nat—A PREROUTNG—p TCP—drop 2181—j DROP” is utilized in step 202, the iptables utility is utilized to delete the above described rule of DROP in the pre-routing chain from the NAT tables of the servers such that the servers are configured back to the state of receiving the service requests from clients. An exemplary command can be “iptables—t nat—D PREROUTING—p TCP—dport 2181—j DROP”.

In accordance with embodiments of the present disclosure, when the servers of the ZooKeeper™ service enter a state of leader election, the configuring of a rule of DROP for the TCP port designated for the ZooKeeper™ service to receive requests from clients in the chains and the IP tables of the servers renders the servers to no longer receive service requests. After the completion of the running of leader election, with a newly elected leader and the servers of the ZooKeeper™ service returning to servicing the external clients, the prior configuration of the rule of packet processing for the servers is cleared such that the servers of they go back to the state of receiving service requests from the clients. With this, when in the state of leader election, the servers of the ZooKeeper™ service no longer receive requests from the clients to perform tasks such as, for example, logging, inquiring or responding, therefore the servers can focus on completing the leader election. In other words, the requests sent from the clients will no longer delay or interfere with the process of leader election by the servers of the ZooKeeper™ service, leading to a fast and successful leader election.

Referring to FIG. 3, a block diagram of an exemplary apparatus for fast leader election by a coordination service for distributed systems is shown in accordance with embodiments of the present disclosure. Apparatus 300 may operate in an environment such as, for example, the ZooKeeper™ coordination service 102 of FIG. 1. In some other embodiments, the apparatus 300 may also operate in any other coordination services of distributed systems and/or the combination thereof.

As shown in FIG. 3, apparatus 300 includes a leader election state determination module 301, a client request rejecting configuration module 302, a service providing state determination module 303 and a client request receiving configuration module 304. The leader election state determination module 301 is configured to determine whether the servers of the ZooKeeper™ service system have entered a state of leader election. The leader election state determination module 301 can implement the step 201 of method 200 to determine whether the servers are in the state of leader election. When it is determined that the servers are not running a leader election, the leader election state determination module 301 repeats the step 201 of method 200 to monitor whether the servers have entered into the state of leader election. After it is determined that the servers are in the state of leader election, the leader election state determination module 301 sends signals to instruct the client request rejecting configuration module 302 to initiate execution.

The client request rejecting configuration module 302 is configured to configure the servers of the ZooKeeper™ service system in a state of rejecting requests from clients. After receiving the signals from the leader election determination module 301, the client request rejecting configuration module 302 implements the above described step 202 of method 200 to configure the servers of the ZooKeeper™ service system in a state of rejecting requests from clients. Afterwards, the client request rejecting configuration module 302 sends signals to instruct the service providing state determination module 303 to initiate execution.

The service providing state determination module 303 is configured to determine whether the servers of the ZooKeeper™ service system are in the state of servicing external clients. After receiving the signals from the client request rejecting configuration module 302, the service providing state determination module 303 implements the above described step 203 of method 200 to determine whether the servers of the ZooKeeper™ system have entered the state of servicing the clients. If it is determined that the servers have not entered the state of servicing the clients, the service providing state determination module 303 repeats the step 203 of method 200 to monitor whether the servers of the ZooKeeper™ system have entered the state of servicing clients. Otherwise, if it is determined that the servers have entered into the state of servicing the clients, the service providing state determination module 303 sends signals to instruct client request receiving configuration module 304 to initiate execution.

The client request receiving configuration module 304 is configured to configure the servers of the ZooKeeper™ system back into the state of servicing external clients. After receiving the signals from the service providing state determination module 303, the client request receiving configuration module 304 implements the above described step 204 of method 200 to configure the servers into the state of providing services.

In accordance to embodiments of the present disclosure, when it determines that the servers of the ZooKeeper™ system are in the state of leader election, apparatus 300 configures the servers in a state of rejecting client requests. When it determines that the servers are back in the state of servicing clients, apparatus 300 configures the servers back in a state of receiving service requests from clients. In this manner, apparatus 300 achieves the effect of running a fast leader election as well as a fast recovery to providing service by the servers of the ZooKeeper™ service system.

In some alternative embodiments, an exemplary system for fast leader election by the servers of the ZooKeeper™ system includes a processor, a memory, an input device and an output device. The memory has software instructions stored thereon to be executed when accessed by the processor to perform the process of fast leader election. The process of the fast leader election are substantially similar to the embodiments illustrated in the above described method of fast leader election by the coordination service and details are not repeated herein for the purpose of simplicity.

Embodiments of the present disclosure can be implemented using software, hardware, firmware, and/or the combinations thereof. Regardless of being implemented using software, hardware, firmware or the combinations thereof, instruction code can be stored in any kind of computer readable media (for example, permanent or modifiable, volatile or non-volatile, solid or non-solid, fixed or changeable medium, etc.). Similarly, such medium can be implemented using, for example, programmable array logic (PAL), random access memory (RAM), programmable read only memory (PROM), read only memory (ROM), electrically erasable programmable ROM (EEPROM), magnetic storage, optical storage, digital versatile disc (DVD), or the like.

It is appreciated that, modules or blocks described by embodiments of the present disclosures are logical modules or logical blocks. Physically, a logical module or logical block can be a physical module or a physical block, a part of a physical module or a physical block, or the combinations of more than one physical modules or physical blocks. Physical implementation of those logical module or logical blocks is not necessary functionalities realized by the modules, blocks and the combinations thereof are key to solving the problems addressed by the present disclosure. Further, in order to disclose the novelties of the present disclosure, the above described embodiments do not disclose those modules or blocks not too related to solving the problems addressed by the present disclosure, which does not mean that the above described embodiments cannot include other modules or blocks.

It is also necessary to point out that, in the claims and specification of the present disclosure, terms such as first and second only are for distinguishing an embodiment or an operation from another embodiment or operation. It does not require or imply that those embodiments or operations have any such real relationship or order. Further, as used herein, the terms “comprising,” “including,” or any other variation intended to cover a non-exclusive inclusion, such that a process, method, article, or apparatus that comprises a list of elements does not include only those elements but may include other elements not expressly listed or inherent to such process, method, article, or apparatus. Absent further limitation, elements recited by the phrase “comprising a” does not exclude a process, method, article, or apparatus that comprises such elements from including other same elements.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable medium used to actually carry out the distribution. The embodiments disclosed herein may also be implemented using software modules that perform certain tasks. These software modules may include script, batch, or other executable files that may be stored on a computer-readable storage media or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present disclosure and its advantages have been described in detail, it should be understood that various changes substitutions, and alterations can be made herein without departing from the spirit and scope of the disclosure as defined by the appended claims. Many modifications and variations are possible in view of the above teachings. The embodiments were chosen and described in order to best explain the principles of the disclosure and its practical applications, to thereby enable others skilled in the art to best utilize the disclosure and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

What is claimed is:

1. A method of leader election by a coordination service for distributed systems, the coordination service servicing clients with a plurality of servers, the plurality of servers electing a leader, the method comprising:
determining whether the servers of the coordination service are in a state of leader election;
in response to a determination that the servers of the coordination service are in the state of leader election, configuring the servers of the coordination service in a state of rejecting requests from the clients;
determining whether the servers of the coordination service are in a state of servicing clients; and
in response to a determination that the servers of the coordination service are in the state of servicing clients, configuring the servers of the coordination service in a state of receiving requests from clients.

2. The method of claim 1, wherein the configuring the servers of the coordination service in the state of rejecting requests from clients comprises configuring a packet processing rule of drop in an input chain of an IP table of a server of the coordination service, the IP table being one of a filter table or a mangle table, and wherein further the configuring the servers of the coordination service in the state of receiving requests from clients comprises clearing the packet processing rule of drop in the input chain of the IP table of the server of the coordination service.

3. The method of claim 2, wherein the configuring the packet processing rule of drop in the input chain of the IP table of the server of the coordination service comprises configuring a packet processing rule of drop for a designated TCP port in the input chain of the IP table of the server of the coordination service, and wherein further the clearing the packet processing rule of drop in the input chain of the IP table of the server of the coordination service comprises clearing the packet processing rule of drop for the designated TCP port in the input chain of the IP table of the server of the coordination service, and wherein the designated TCP port is a TCP port where the server of the coordination service receives the requests from the clients.

4. The method of claim 3, wherein the configuring the packet processing rule of drop for the designated TCP port in the input chain of the IP table of the server of the coordination service comprises adding a packet processing rule of drop for the designated TCP port in the input chain of the IP table of the server of the coordination service, and wherein further the clearing the packet processing rule of drop for the designated TCP port in the input chain of the IP table of the server of the coordination service comprises deleting the packet processing rule of drop for the designated TCP port in the input chain of the IP table of the server of the coordination service.

5. The method of claim 4, wherein the adding the packet processing rule of drop for the designated TCP port in the input chain of the IP table of the server of the coordination service comprises adding, by use of a networking utility, a packet processing rule of drop for the designated TCP port in the input chain of the IP table of the server of the coordination service, and wherein further the deleting the packet processing rule of drop for the designated TCP port in the input chain of the IP table of the server of the coordination service comprises deleting, by use of the networking utility, the packet processing rule of drop for the designated TCP port in the input chain of the IP table of the server of the coordination service.

6. The method of claim 3, wherein the server of the coordination service receives the requests from the clients at TCP port 2181.

7. The method of claim 1, wherein the configuring the servers of the coordination service in the state of rejecting requests from the clients comprises configuring a packet processing rule of drop in a pre-routing chain of an IP table of a server of the coordination service, the IP tables being one of a network address translation table or a mangle table, and wherein further the configuring the servers of the coordination service as receiving the requests from the clients comprises clearing the packet processing rule of drop in the pre-routing chain of the IP table of the server of the coordination service.

8. The method of claim 7, wherein the configuring the packet processing rule of drop in the pre-routing chain of the IP table of the server of the coordination service comprises configuring a packet processing rule of drop for a designated TCP port in the pre-routing chain of the IP table of the server of the coordination service, and wherein further the clearing the packet processing rule of drop in the pre-routing chain of the IP table of the server of the coordination service comprises clearing the packet processing rule of drop for the designated TCP port in the pre-routing chain of the IP table of the server of the coordination service, and wherein the designated TCP port is a TCP port where the server of the coordination service receives the requests from the clients.

9. The method of claim 8, wherein the configuring the packet processing rule of for the designated TCP port in the pre-routing chain of the IP table of the server of the coordination service comprises adding a packet processing rule of drop for the designated TCP port in the pre-routing chain of the IP table of the server of the coordination service, and wherein further the clearing the packet processing rule of drop for the designated TCP port in the pre-routing chain of the IP table of the server of the coordination service comprises deleting the packet processing rule of drop for the designated TCP port in the pre-routing chain of the IP table of the server of the coordination service.

10. The method of claim 9, wherein the adding the packet processing rule of drop for the designated TCP port in the pre-routing chain of the IP table of the server of the coordination service comprises adding, by use of a networking utility, a packet processing rule of drop for the designated TCP port in the pre-routing chain of the IP table of the server of the coordination service, and wherein further the deleting the packet processing rule of drop for the designated TCP port in the pre-routing chain of the IP table of the server of the coordination service comprises deleting, by use of the networking utility, the packet processing rule of drop for the designated TCP port in the pre-routing chain of the IP table of the server of the coordination service.

11. The method of claim 8, wherein the server of the coordination service receives the requests from the clients at TCP port 2181.

12. The method of claim 1, wherein the determining whether the servers of the coordination service are in the state of leader election comprises:
initiating a monitor program to analyze a log file output by the coordination service; and
if the log file outputs information indicating the state of leader election, determining that the servers of the coordination service are in the state of leader election.

13. The method of claim 1, wherein the determining whether the servers of the coordination service are in the state of leader election comprises:
initiating a monitor program to utilize a status command to query a status of the servers of the coordination service; and
if information returned by the servers in response to the status command contains information indicating errors contacting the servers of the coordination service and if a port at which the servers of the coordination service receive the requests from the clients is alive, determining that the servers of the coordination service are in the state of leader election.

14. The method of claim 1, wherein the determining whether the servers of the coordination service are in the state of leader election comprises:
initiating a monitor program to utilize a coordination service command to query the servers of the coordination service; and
if information returned by the servers of the coordination service in response to the coordination service command does not indicate a running status, determining that the servers of the coordination service are in the state of leader election.

15. The method of claim 1, wherein the determining whether the servers of the coordination service are in the state of servicing clients comprises: initiating a monitor program to utilize a coordination service command to query the servers of the coordination service; and if information returned by the servers of the coordination service in response to the coordination service command indicates a running status, determining that the servers of the coordination service are in the state of servicing the clients.

16. The method of claim 1, wherein the determining whether the servers of the coordination service are in the state of servicing the clients comprises:
utilizing a status command to query a status of the servers of the coordination service; and
if information returned by the servers of the coordination service in response to the status command contains information indicating “follower” or “leader”, determining that the servers of the coordination service are in the state of servicing the clients.

17. An apparatus for leader election by a coordination service for distributed systems, the apparatus comprising:
a processor; and
a non-transitory computer-readable medium operably coupled to the processor, the non-transitory computer-readable medium having computer-readable instructions stored thereon to be executed when accessed by the processor, the instructions comprising:
a leader election status determination module that determines whether the servers of the coordination service are in a state of leader election;
a client request rejecting configuration module, in response to a determination that the servers of the coordination service are in the state of leader election, which configures the servers of the coordination service in a state of rejecting requests from clients;
a servicing status determination module that determines whether the servers of the coordination service are in a state of servicing clients; and
a client request receiving configuration module, in response to a determination that the servers of the coordination service are in the state of servicing the clients, which configures the servers of the coordination service in a state of receiving requests from clients.

18. A non-transitory computer readable storage medium having embedded therein program instructions, when executed by one or more processors of a device, causes the device to execute a process for fast leader election by a coordination service for distributed systems, the process comprising:
determining whether the servers of the coordination service are in a state of leader election;
in response to a determination that the servers of the coordination service are in the state of leader election, configuring the servers of the coordination service in a state of rejecting requests from clients;
determining whether the servers of the coordination service are in a state of servicing the clients; and
in response to a determination that the servers of the coordination service are in the state of servicing the clients, configuring the servers of the coordination service in a state of receiving requests from clients.

19. The non-transitory computer readable storage medium of claim 18, wherein the configuring the servers of the coordination service in the state of rejecting the requests from the clients comprises configuring a packet processing rule of drop in an input chain of an IP table of a server of the coordination service, the IP table being one of a filter table or a mangle table, and wherein the configuring the servers of the coordination service in the state of receiving requests from the clients comprises clearing the packet processing rule of drop in the input chain of the IP table of the server of the coordination service.

20. The non-transitory computer readable storage medium of claim 18, wherein the determining whether the servers of the coordination service are in the state of leader election comprises:
initiating a monitor program to analyze a log file output by the coordination service; and
if the log file currently outputs information indicating the state of leader election, determining that the servers of the coordination service are in the state of leader election.
